(19) United States
(12) Patent Application Publication
(10) Pub. No.: US 2008/0232329 A1
(43) Pub. Date: Sep. 25, 2008

(54) Method and Apparatus for Handling Random Access Procedure in a Wireless Communications System

(76) Inventor: Yu-Chih Jen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/053,529

(22) Filed: Mar. 21, 2008

Related U.S. Application Data
(60) Provisional application No. 60/895,987, filed on Mar. 21, 2007.
(60) Provisional application No. 60/945,948, filed on Jun. 25, 2007.

(51) Int. Cl. H04B 7/216

(52) U.S. Cl. 370/335

(57) ABSTRACT

A method for handling a random access procedure in a wireless communications system comprises a network dividing access resources of a random access channel into at least one group, a UE randomly choosing a group of the at least group when the UE performs random access preamble or dedicated preamble based procedures.

### CROSS REFERENCE TO RELATED APPLICATIONS

This application claims the benefit of U.S. Provisional Application No. 60/895,987, filed on Mar. 21, 2007 and entitled “Method and Apparatus to improve LTE Random access procedure”, the benefit of U.S. Provisional Application No. 60/945,948, filed on Jun. 25, 2007 and entitled “Method and Apparatus to optimize Random Access Procedure”, the contents of which are incorporated herein by reference.

### BACKGROUND OF THE INVENTION

1. Field of the Invention

The present invention relates to a method and apparatus for handling random access procedure in a wireless communications system, and more particularly, to a method and apparatus for implementing timing alignment and resource request, so as to enhance system efficiency.

2. Description of the Prior Art

The third generation mobile telecommunications system (called 3G system) provides high frequency spectrum utilization, universal coverage, and high quality, high-speed multimedia data transmission, and also meets all kinds of QoS requirements simultaneously, providing diverse, flexible, two-way transmission services and better communication quality to reduce transmission interruption rates. However, due to demand for high-speed and multimedia applications, the next generation mobile telecommunications technology and related communication protocols have been developed.

In the Long Term Evolution wireless communications system (LTE system), a Random Access Channel (RACH) is configured in an uplink (UL) channel between a user equipment (UE) and the network, and utilized for timing alignment, RNTI (Radio Network Temporary Identifier) assignment, and resource request. In the starting state, only downlink (DL) timing between UE and Node B (NB) is synchronized, and signals on RACH can be used for UL timing alignment. Before performing UL timing alignment, UE uses downlink Synchronization Channel or reference signals to perform synchronization on timing and frame. However, since signals may be delayed due to a distance between the transmitter and receiver, UE is not able to determine whether a message transmitted from UE is at a starting position of a receiving frame of NB. In addition, when NB provides service for multiple UEs at the same time, Round Trip Delays (RTDs) between each UE and NB may be different due to different distances thereof, causing timing offset. Therefore, NB evaluates timing offset of a UE according to RACH signals from the UE, and notifies the UE to adjusting UL timing via Downlink Shared Channel (DL-SCH), to achieve timing synchronization. A RACH signal is composed of preambles used for UL timing synchronization and UE identity detection, or carrying short signaling or signature.

On the other hand, RACH signals among different UEs are transmitted to NB by contention-based or non-contention-based method. That is, UE can select a RACH transmission opportunity and randomly select a preamble to transmit signals, or transmit a signal carrying a preamble assigned by the network (in such a situation, the RACH transmission opportunity is assigned by the network or selected by the UE). If the network cannot identify the transmitted RACH signal due to collision or low power, or if contention lost occurs due to a randomly-selected preamble, the UE can retransmit the RACH signal with larger power in the next available RACH transmission opportunity, until a response from the network is received or a condition is reached, e.g., maximum transmitting or maximum power.

For LTE, a RACH transmission opportunity is related to a time-frequency radio resource, not only related to time or frequency. Therefore, when RACH physical resource is selected, its time period and frequency band are determined. Of course, at certain time period, there may be more than one frequency sub-band for selection. On the other hand, preamble can be random access preamble, which is randomly selected by UE, or dedicated preamble, which is assigned by network (source cell or target cell). Basically, when UE uses (randomly selected) random access preamble, there is possibility another UE use the same preamble and transmit it in the same RACH opportunity so that network doesn't know whether the signal comes from one or more than one UE. Consequently, contention exists and will be solved after UE sends its UE identity in subsequent message 3. In contrary, dedicated preamble is assigned by network to a known specific UE so it's unique and won't cause contention between UEs (no another UE use the same dedicated preamble.)

In LTE, asynchronous RACH is concluded and adopted as working assumption where dedicated preamble and random access preamble based RACH accesses may both be supported. Random access procedure performance mainly in terms of latency and overhead is affected by collision/contention probability, time/frequency resources, number of user equipments (load), number of preamble signature, channel quality, UE identities, and even access causes and so on. On the other hand, the design requirements in addition to performance, such as short life span of identity usage, to be common for various kinds of non-synchronous RACH accesses in E-UTRAN (eNB and aGW) for FDD and TDD as well as irrespective of cell size, optimization for connected state UEs, are considered while possible reasons for UE to access on RACH can be categorized into four main causes, which are initial access (e.g. UE originated call, network originated call, tracking area update and initial cell access) including initial NAS signaling for NAS procedures (e.g. service request, network attach, routing/tracking area update), synchronization request, handover access and scheduling request. According to requirements and need of support for possible access causes, the baseline random access procedure model and channel mapping (between logical channels and transport channels) are defined in the prior art. Current decision on four steps of random access procedures is shown as following:

(1) Step “Random Access Preamble on RACH in uplink”: is corresponding to a message 1, which carries 6 bits, and indicates a random ID, and possibly other information, e.g., cause or size, potentially with priority, pathloss or CQI to allocate UL resource appropriately.

(2) Step “Random Access Response on DL-SCH”: is corresponding to a message 2, which is semi-synchronous (within a flexible window of which the size is one or more TTI) with message 1, no HARQ (Hybrid Automatic Repeat Request) support, transmitted on L1/L2+DL-SCH, addressed to RA-RNTI (Random Access RNTI) on L1/L2 control channel, conveys at least RA-preamble identifier, timing alignment information, initial UL grant and assignment of Temporary Cell RNTI (T-CRNTI), and is intended for one or multiple UEs in one DL-SCH message.

(3) Step “First scheduled UL transmission on UL-SCH”: is corresponding to a message 3, which uses HARQ, operates in RLC TM (Radio Link Control Transparent Mode) without segmentation, conveys at least UE identifier and (explicit or implicit) information on whether C-RNTI is already available. Besides, in case of initial access and if the size of the message allows it, the initial NAS message (or something allowing to build the initial NAS message in eNB) can be included, and size of the message is dynamic.

(4) Step “Contention Resolution on DL-SCH”: is corresponding to a message 4, which is not synchronized with message 3, and addressed to the Temporary C-RNTI on L1/L2 control channel (at least for initial access). Besides, content of the message is FFS (for further study), HARQ is supported, and HARQ feedback is transmitted only by the UE which detects its own UE identity, as provided in message 3, echoed in the RRC (Radio Resource Control) Contention Resolution message.

In the prior art, at initial access, the four steps are: Random Access Preamble on RACH, Random Access Response via CCCH (Common Control Channel) on DL-SCH, RRC Connection Request via CCCH on UL-SCH, and RRC Contention Resolution via DCCH on DL-SCH.

Therefore, for LTE, the prior art provides steps of RA procedure. However, some problems may occur.

It's known that it's insufficient to provide non-contention based RA to a large number of connected state users (including UEs in long_DRX), especially when there is not enough RACH time/frequency resources for expansion or being dedicated to serve random access and dedicated preamble separately (e.g. dedicated resources for dedicated preamble, other resources for random access preamble). Running out of preamble space for dedicated preamble will increase contention probability for random access preamble. In contrast, it's also not a good way to assign a dedicated preamble to UEs if resource is too sparse to distinguish them, which may disaster both UEs with dedicated preamble and random access preamble.

Message 2 content includes preamble identifier, timing alignment, initial UL grant, and temporary C-RNTI (e.g. information contents for each UE) and is intended to one or more UEs in one DL-SCH message. The size of message 2 may be limited in terms of BLER, coverage reliability, and interference level. Therefore, it is necessary to reduce the message 2 size during certain circumstance while keeping randomness feature for random access procedure or RACH access. It's expected that reducing bits for each information field or segmentation of the message can achieve the size reduction of message 2. However, message 2 should not be segmented into too many segments since it's a waste to not provide more access chances and it's unfair for UEs having DL-SCH channel in good radio condition. How network determines the size of message 2/sub-message 2, how to reduce the message size, and how to utilized the saved bits from reduction of bit(s) of field should be specified.

Since network will determine how to reduce the size of message 2 according to current location situation, it's not proper to have size of message 2 to be equal in all locations. In addition, various causes of random access may require some distinct information in message 2. Consequently, the different sizes adopting for different situations/locations and access purposes can further affect the possibility of optimisation or reduction of field size. In addition, how network indicates size reduction mechanism (e.g. how many segments, how many bits for a reduced field if any) should be specified.

Since network can determine how to segment message 2 (so as to the size of sub-message 2), the indicator of message 2 for UEs can address to different number of UEs on control channel. Therefore, with dynamic decision made by network, the UE should know whether current message 2 of possible distinct size is intended for it. Otherwise, the UE may not detect message 2 intended for it. In addition, the saved bits in message 2 should be fully utilized.

### SUMMARY OF THE INVENTION

According to the claimed invention, a method for handling a random access procedure in a wireless communications system comprises a network dividing access resources of a random access channel into at least one group, a UE randomly choosing a group of the at least group when the UE performs random access preamble or dedicated preamble based procedures.

According to the claimed invention, a method for handling a random access procedure in a network of a wireless communications system comprises dividing a plurality of random access preambles or preambles used in accesses of a random access channel into at least one group; and making each of the at least one group to be mapped to or configured to at least one RA-RNTI or radio time and frequency resources, or using at least one RA-RNTI or radio time and frequency resources to represent mapping of each of the at least one group.

According to the claimed invention, a method for handling a random access procedure in a wireless communications system comprises determining characteristic of access of a random access channel in a specific or dynamic manner.

According to the claimed invention, a method for handling a random access procedure in a wireless communications system comprises transmitting decision or configuration corresponding to information or grouping information of the random access procedure to a UE via a specified message or signaling transmitted by a network.

According to the claimed invention, a method for handling a random access procedure in a user equipment, called UE hereinafter, of a wireless communications system comprises detecting or extracting information intended to the UE according to a derived or received grouping information.

According to the claimed invention, a method for handling a random access procedure in a network of a wireless communications system comprises dividing a message 2 into certain number of sub-messages each conveying information for a group of UEs.

According to the claimed invention, a method for handling a random access procedure in a wireless communications system comprises when a RA-RNTI with a first number of bits is utilized for representing a group, dividing the RA-RNTI into at least a first part for distinguishing the group and a second part for conveying additional control information on downlink control channel.

According to the claimed invention, a method for handling a random access procedure in a wireless communications system comprises a UE having received information or grouping information of a random access procedure, a network addressing information corresponding to a UE group to a UE via RA-RNTI, or transmitting information corresponding to the UE group via specified radio resources.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises a network dividing access resources of a random access channel into at least one group, a UE randomly choosing a group of the at least group when the UE performs random access preamble or dedicated preamble based procedures.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises dividing a plurality of random access preambles or preambles used in accesses of a random access channel into at least one group; and making each of the at least one group to be mapped to or configured to at least one RA-RNTI or radio time and frequency resources, or using at least one RA-RNTI or radio time and frequency resources to represent mapping of each of the at least one group.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises determining characteristic of access of a random access channel in a specific or dynamic manner.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises transmitting decision or configuration corresponding to information or grouping information of the random access procedure to a UE via a specified message or signaling transmitted by a network.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises detecting or extracting information intended to the UE according to a derived or received grouping information.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises dividing a message 2 into certain number of sub-messages each conveying information for a group of UEs.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises when a RA-RNTI with a first number of bits is utilized for representing a group, dividing the RA-RNTI into at least a first part for distinguishing the group and a second part for conveying additional control information on downlink control channel.

According to the claimed invention, a communications device for accurately handling a random access procedure in a wireless communications system comprises a control circuit for realizing functions of the communications device; a processor installed in the control circuit, for executing a program code to command the control circuit; and a memory installed in the control circuit and coupled to the processor for storing the program code; wherein the program code comprises a UE having received information or grouping information of a random access procedure, a network addressing information corresponding to a UE group to a UE via RA-RNTI, or transmitting information corresponding to the UE group via specified radio resources.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 to FIG. 10 are flowcharts of processes according to embodiments of the present invention.

FIG. 11 is a schematic diagram of a wireless communications system.

### DETAILED DESCRIPTION

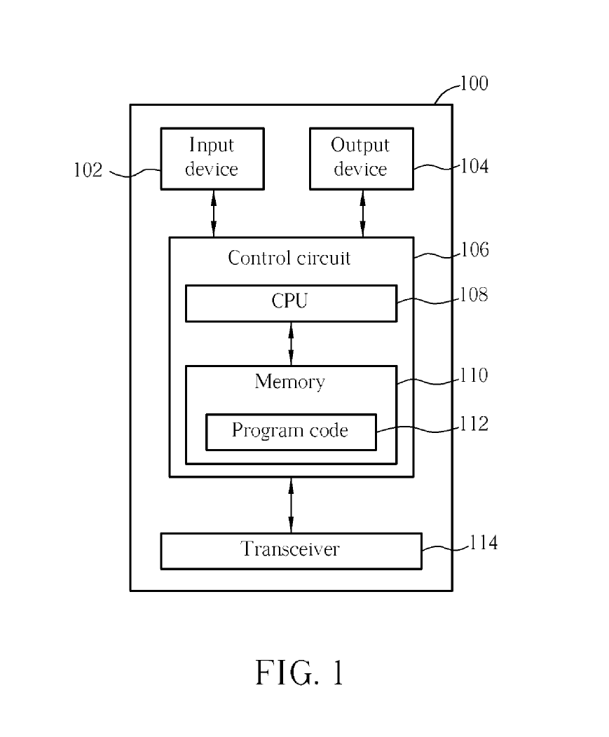

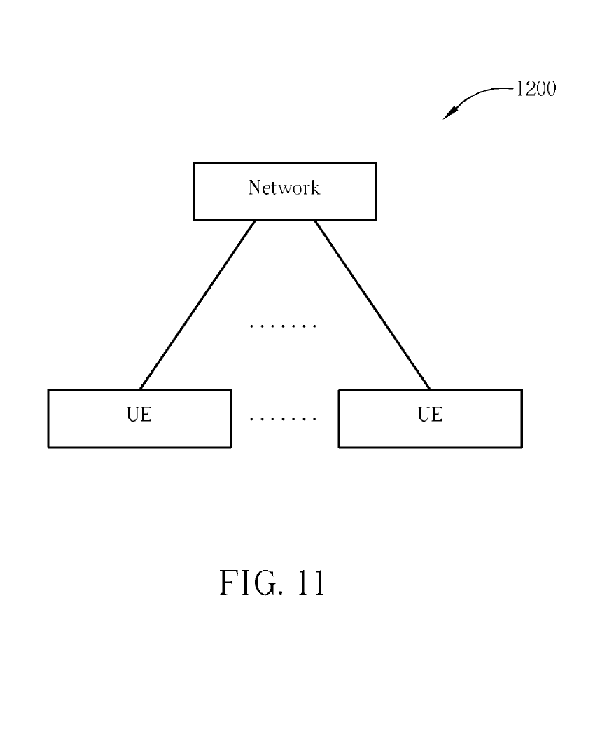

Please refer to FIG. 11, which illustrates a schematic diagram of a wireless communications system 1200. The wireless communications system 1200 is preferably an LTE system, and is briefly composed of a network and a plurality of UEs. In FIG. 1, the network and the UEs are simply utilized for illustrating the structure of the wireless communications system 1200. Practically, the network terminal may comprise a plurality of base stations (or Node B), radio network controllers and so on according to actual demands, and the UEs can be devices such as mobile phones, computer systems, etc.

Please refer to FIG. 1, which is a functional block diagram of a communications device 100. The communications device 100 can be used for implementing the network and the UE shown in FIG. 11. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

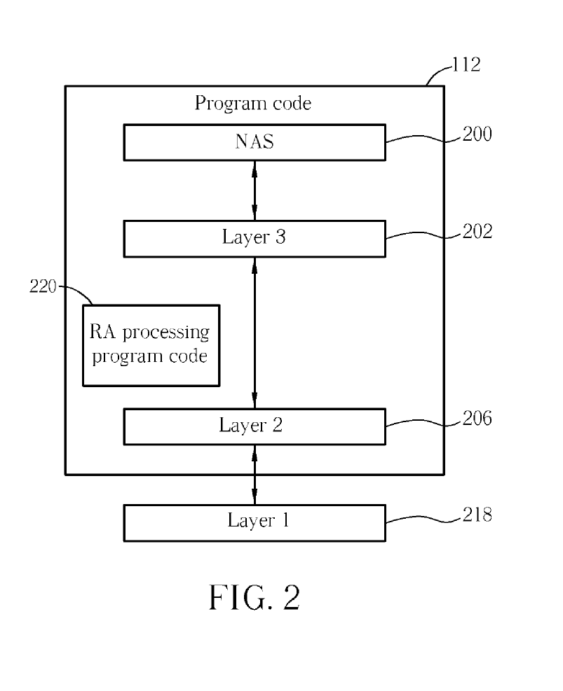

Please continue to refer to FIG. 2. FIG. 2 is a diagram of the program code 112 shown in FIG. 1. The program code 112 includes a Non Access Stratum (NAS) 200, a Layer 3 202, and a Layer 2 206, and is coupled to a Layer 1 218. The NAS 200 can generate NAS messages for realizing NAS applications. The Layer 3 202 is composed of an RRC layer, for performing radio resource control. The Layer 2 206 performs link control, and the Layer 1 218 performs physical connections. Whether a PDCP layer belongs to the Layer 3 202 or the Layer 2 206 is not relevant to this invention.

In order to achieve timing alignment and resource request, a RACH is configured in the communications device 100 for the random access procedure. In such a situation, the embodiment of the present invention provides a RA processing program code 220 for handling a random access procedure, so as to prevent the prior art problems. In the following, definitions of the messages 1, 2, 3, 4 are the same as what mentioned above. That is, the message 1 is corresponding to step “Random Access Preamble on RACH in uplink”, the message 2 is corresponding to step “Random Access Response on DL-SCH”, the message 3 is corresponding to step “First scheduled UL transmission on UL-SCH”, and the message 4 is corresponding to step “Contention Resolution on DL-SCH.”

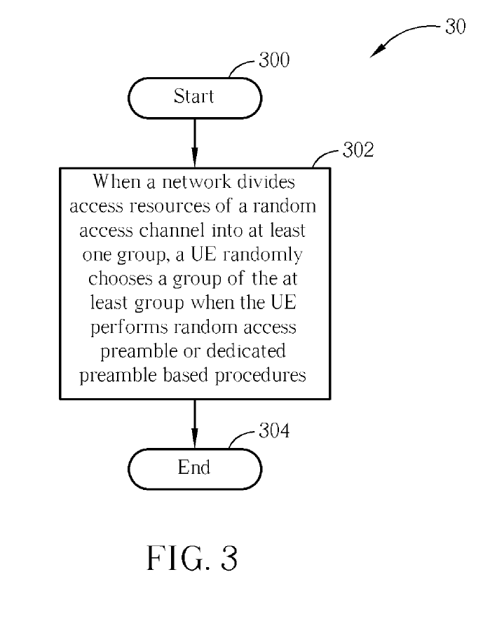

Please refer to FIG. 3, which illustrates a schematic diagram of a process 30 according an embodiment of the present invention. The process 30 is utilized for handling a random access procedure in the wireless communications system 1200, and can be compiled into the RA processing program code 220. The process 30 comprises the following steps:

Step 300: Start.

Step 302: When a network divides access resources of a random access channel into at least one group, a UE randomly chooses a group of the at least group when the UE performs random access preamble or dedicated preamble based procedures.

Step 304: End.

According to the process 30, when a network divides access resources of a random access channel into at least one group, a UE randomly chooses a group of the at least group when the UE performs random access preamble or dedicated preamble based procedures.

Preferably, the network outputs a polling or token to UEs corresponding to a group of the at least one group, to control UEs of the group to trigger random access. Decision on polling or token passing to a group of preambles is made based on service class, priority, performance or QoS of procedures, or, dedicated preamble availability, or load (accessing UEs) of the system.

Therefore, via the process 30, when a network divides access resources of a random access channel into at least one group, a UE randomly chooses a group of the at least group when the UE performs random access preamble or dedicated preamble based procedures.

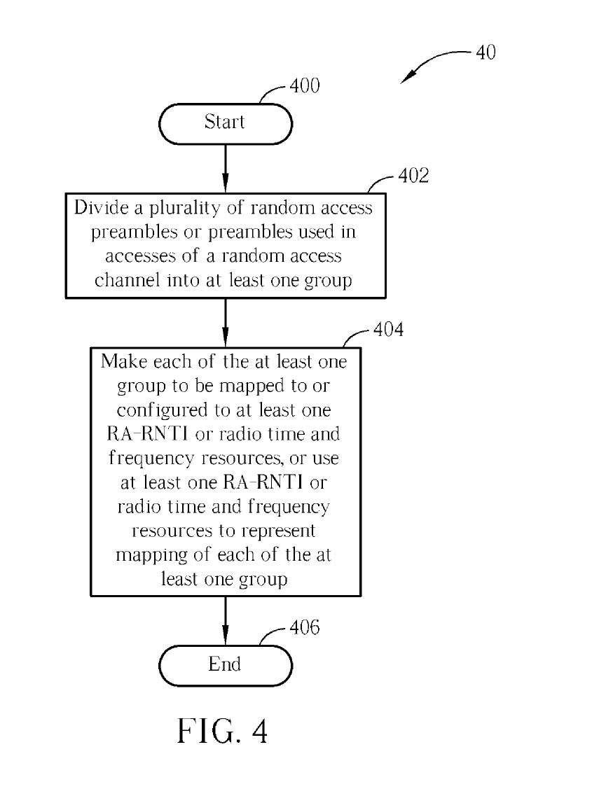

Please refer to FIG. 4, which illustrates a schematic diagram of a process 40 according an embodiment of the present invention. The process 40 is utilized for handling a random access procedure in the wireless communications system 1200, and can be compiled into the RA processing program code 220. The process 40 comprises the following steps:

Step 400: Start.

Step 402: Divide a plurality of random access preambles or preambles used in accesses of a random access channel into at least one group.

Step 404: Make each of the at least one group to be mapped to or configured to at least one RA-RNTI or radio time and frequency resources, or use at least one RA-RNTI or radio time and frequency resources to represent mapping of each of the at least one group.

Step 406: End.

According to the process 40, the embodiment of the present invention divides a plurality of random access preambles or preambles used in accesses of a random access channel into at least one group, and makes each of the at least one group to be mapped to or configured to at least one RA-RNTI or radio time and frequency resources, or use at least one RA-RNTI or radio time and frequency resources to represent mapping of each of the at least one group.

Preferably, dividing the plurality of random access preambles or the preambles used in accesses of the random access channel into at least one group is performed according to regulated size, number of accessing UEs, accessing cause, priority of service or UE, or number of available preambles. The predefined size is determined according to interference, target BLER, coverage reliability, system load, QoS on providing access, accessing causes, or default configuration. The embodiment of the present invention further divides UEs without dedicated preamble into a plurality of groups according to a standardized rule or configuration.

Therefore, via the process 40, the embodiment of the present invention divides a plurality of random access preambles or preambles used in accesses of a random access channel into at least one group, and makes each of the at least one group to be mapped to or configured to at least one RA-RNTI or radio time and frequency resources, or use at least one RA-RNTI or radio time and frequency resources to represent mapping of each of the at least one group.

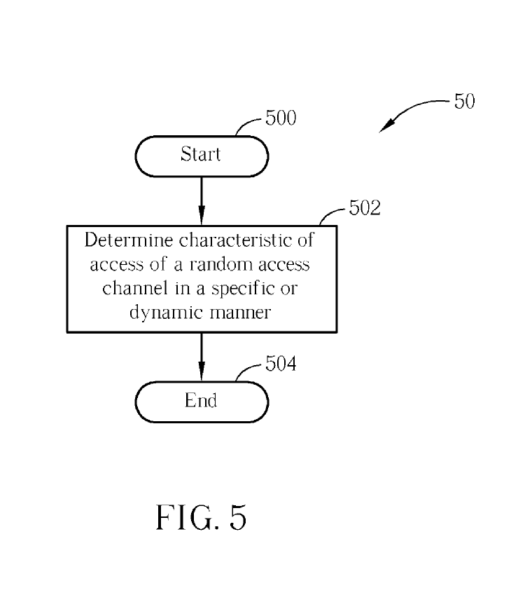

Please refer to FIG. 5, which illustrates a schematic diagram of a process 50 according an embodiment of the present invention. The process 60 is utilized for handling a random access procedure in the wireless communications system 1200, and can be compiled into the RA processing program code 220. The process 50 comprises the following steps:

Step 500: Start.

Step 502: Determine characteristic of access of a random access channel in a specific or dynamic manner.

Step 504: End.

According to the process 50, the embodiment of the present invention determines characteristic of access of a random access channel in a specific or dynamic manner.

Preferably, the specified manner is location, channel-quality, traffic, or QoS manner, while the dynamic manner can be time or radio-resource, traffic, or channel-quality manner.

Therefore, via the process 50, the embodiment of the present invention determines characteristic of access of a random access channel in a specific or dynamic manner.

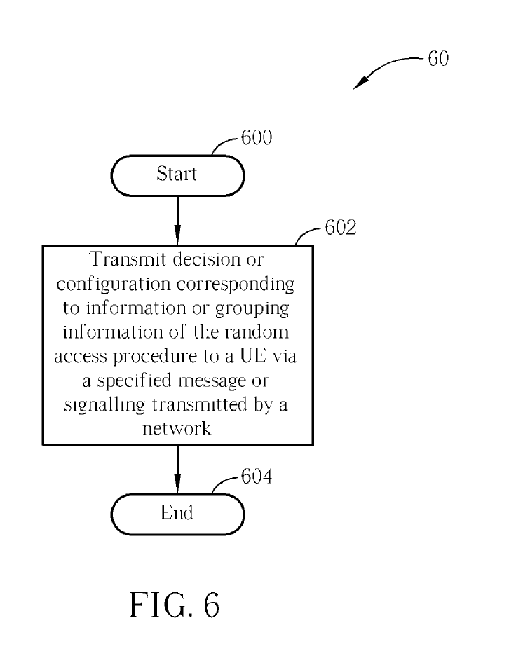

Please refer to FIG. 6, which illustrates a schematic diagram of a process 60 according an embodiment of the present invention. The process 60 is utilized for handling a random access procedure in the wireless communications system 1200, and can be compiled into the RA processing program code 220. The process 60 comprises the following steps:

Step 600: Start.

Step 602: Transmit decision or configuration corresponding to information or grouping information of the random access procedure to a UE via a specified message or signaling transmitted by a network.

Step 604: End.

According to the process 60, the embodiment of the present invention transmits decision or configuration corresponding to information or grouping information of the random access procedure to a UE via a specified message or signaling transmitted by a network.

Preferably, the grouping information is either a set of RA-RNTIs corresponding to RACH access or preambles corresponding to each RA-RNTI, or a set of mapping of radio time or frequency resources to the number of groups or preambles corresponding to each group. The mapping of preambles to each group is received according to a set of RA-RNTIs or a set of radio time or frequency resources according to standardized rules or calculation/mapping. The specific message or signaling can be system information, or network-trigger access message, or message 2, or RRC control message or signaling. The grouping information is additional information field in the said specific message/signaling, as well as either a RA-RNTIs corresponding to RACH access and/or preambles corresponding to the RA-RNTI, or a mapping of radio time/frequency resource to a group and/or preambles corresponding to each group. A UE finds out the grouping information according to the specified message or signaling. The additional information field is an index to indicate how many groups or mapping, or a flag to indicate the fixed number of groups and mapping, or an index to indicate the number of fields for a UE, or a response to cause of making random access. A UE receives the mapping of preambles to each group for a set of RA-RNTIs or a set of radio time or frequency resources according to standardized rules or calculation or mapping.

Therefore, via the process 60, the embodiment of the present invention transmits decision or configuration corresponding to information or grouping information of the random access procedure to a UE via a specified message or signaling transmitted by a network.

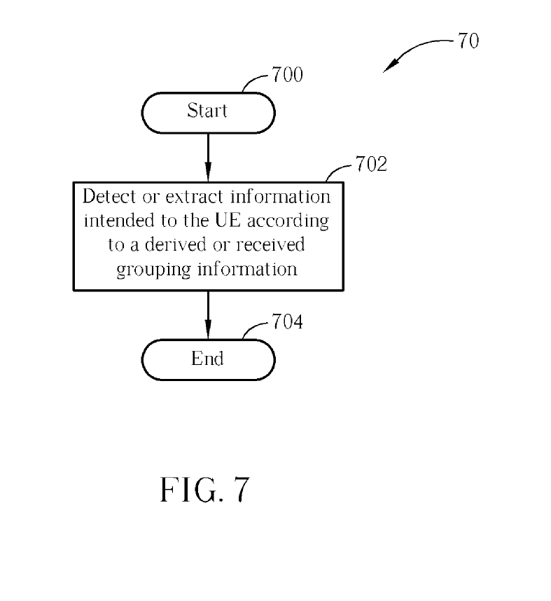

Please refer to FIG. 7, which illustrates a schematic diagram of a process 70 according an embodiment of the present invention. The process 70 is utilized for handling a random access procedure in a UE of the wireless communications system 1200, and can be compiled into the RA processing program code 220. The process 70 comprises the following steps:

Step 700: Start.

Step 702: Detect or extract information intended to the UE according to a derived or received grouping information.

Step 704: End.

According to the process 70, the embodiment of the present invention detects or extracts information intended to the UE according to a derived or received grouping information.

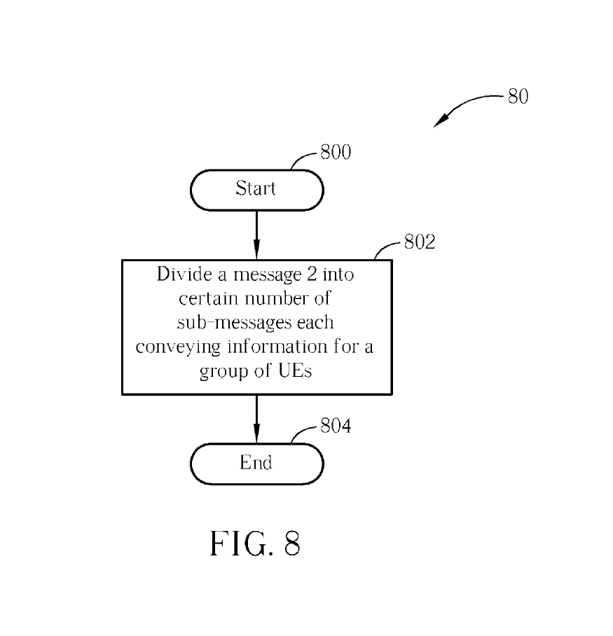

Please refer to FIG. 8, which illustrates a schematic diagram of a process 80 according an embodiment of the present invention. The process 80 is utilized for handling a random access procedure in a network of the wireless communications system 1200, and can be compiled into the RA processing program code 220. The process 80 comprises the following steps:

Step 800: Start.

Step 802: Divide a message 2 into certain number of sub-messages each conveying information for a group of UEs.

Step 804: End.

According to the process 80, the embodiment of the present invention divides a message 2 into certain number of sub-messages each conveying information for a group of UEs.

Preferably, each UE of the group knows which group it belongs to, what information on control channel is intended to or addressed to it, what information is to distinguish the group or which radio time/frequency resource it shall monitor/receive, and which part of sub-message it shall receive or detect. The number of UEs in each the said group is different, or the number of bits used for preamble identifier in different sub-message is different.

Therefore, via the process 80, the embodiment of the present invention divides a message 2 into certain number of sub-messages each conveying information for a group of UEs.

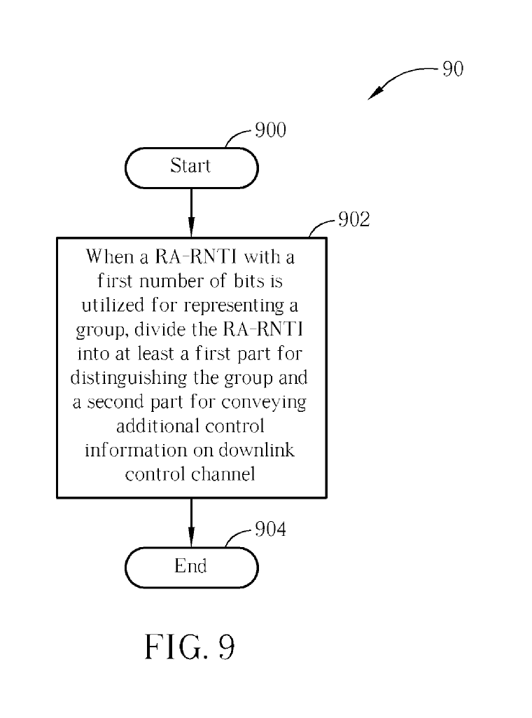

Please refer to FIG. 9, which illustrates a schematic diagram of a process 90 according an embodiment of the present invention. The process 90 is utilized for handling a random access procedure in the wireless communications system 1200, and can be compiled into the RA processing program code 220. The process 90 comprises the following steps:

Step 900: Start.

Step 902: When a RA-RNTI with a first number of bits is utilized for representing a group, divide the RA-RNTI into at least a first part for distinguishing the group and a second part for conveying additional control information on downlink control channel.

Step 904: End.

According to the process 90, the embodiment of the present invention divides the RA-RNTI into at least a first part for distinguishing the group and a second part for conveying additional control information on downlink control channel when a RA-RNTI with a first number of bits is utilized for representing a group.

Preferably, the second part can indicate control information of sub-message, or how many RA-RNTIs to decide whether need to keep monitoring the control channel

Therefore, via the process 90, the embodiment of the present invention divides the RA-RNTI into at least a first part for distinguishing the group and a second part for conveying additional control information on downlink control channel when a RA-RNTI with a first number of bits is utilized for representing a group.

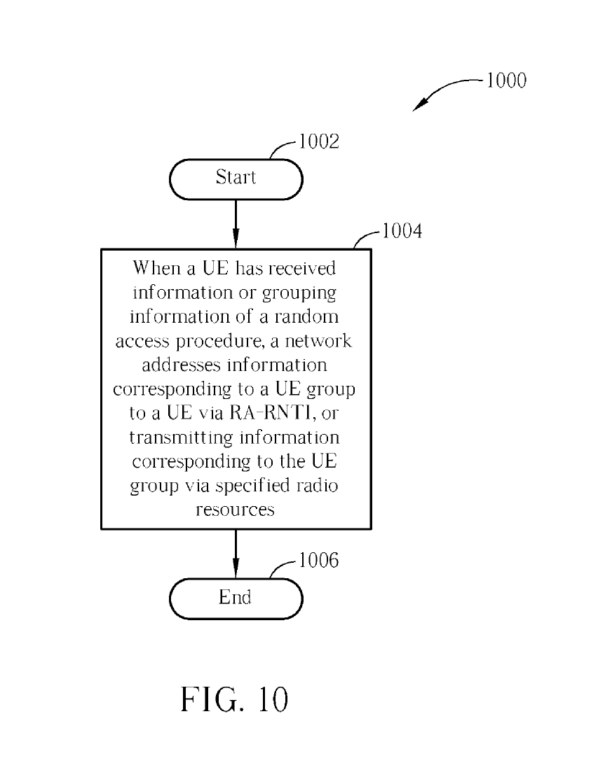

Please refer to FIG. 10, which illustrates a schematic diagram of a process 1000 according an embodiment of the present invention. The process 1000 is utilized for handling a random access procedure in the wireless communications system 1200, and can be compiled into the RA processing program code 220. The process 1000 comprises the following steps:

Step 1002: Start.

Step 1004: When a UE has received information or grouping information of a random access procedure, a network addresses information corresponding to a UE group to a UE via RA-RNTI, or transmitting information corresponding to the UE group via specified radio resources.

Step 1006: End.

According to the process 1000, when a UE has received information or grouping information of a random access procedure, a network addresses information corresponding to a UE group to a UE via RA-RNTI, or transmitting information corresponding to the UE group via specified radio resources.

In summary, the embodiment of the present invention provides different operations of the random access procedure, to achieve timing alignment and resource request.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling a random access procedure in a wireless communications system comprising:
a network dividing access resources of a random access channel into at least one group, a UE randomly choosing a group of the at least group when the UE performs random access preamble or dedicated preamble based procedures.

2. The method of claim 1, further comprising outputting a polling or token to UEs corresponding to a group of the at least one group, to control UEs of the group to trigger random access.

3. The method of claim 2, wherein decision on polling or token passing to a group of preambles is made based on service class, priority, performance or QoS of procedures, or, dedicated preamble availability, or load of the system.

4. A method for handling a random access procedure in a network of a wireless communications system comprising:
dividing a plurality of random access preambles or preambles used in accesses of a random access channel into at least one group; and
making each of the at least one group to be mapped to or configured to at least one RA-RNTI or radio time and frequency resources, or using at least one RA-RNTI or radio time and frequency resources to represent mapping of each of the at least one group.

5. The method of claim 4, wherein dividing the plurality of random access preambles or the preambles used in accesses of the random access channel into at least one group is performed according to regulated size, number of accessing UEs, accessing cause, priority of service or UE, or number of available preambles.

6. The method of claim 5, wherein the predefined size is determined according to interference, target BLER, coverage reliability, system load, QoS on providing access, accessing causes, or default configuration.

7. The method of claim 4, further comprising dividing UEs without dedicated preamble into a plurality of groups according to a standardized rule or configuration.

8. A method for handling a random access procedure in a wireless communications system comprising:
determining characteristic of access of a random access channel in a specific or dynamic manner.

9. The method of claim 8, wherein the specified manner is location, channel-quality, traffic, or QoS manner.

10. The method of claim 8, wherein the dynamic manner can be time or radio-resource, traffic, or channel-quality manner.

11. A method for handling a random access procedure in a wireless communications system comprising:
transmitting decision or configuration corresponding to information or grouping information of the random access procedure to a UE via a specified message or signaling transmitted by a network.

12. The method of claim 11, wherein the grouping information is either a set of RA-RNTIs corresponding to RACH access or preambles corresponding to each RA-RNTI, or a set of mapping of radio time or frequency resources to the number of groups or preambles corresponding to each group.

13. The method of claim 12, wherein the mapping of preambles to each group is received according to a set of RA-RNTIs or a set of radio time or frequency resources according to standardized rules or calculation/mapping.

14. The method of claim 11, wherein the specific message or signaling can be system information, or network-trigger access message, or message 2, or RRC control message or signaling.

15. The method of claim 14, wherein the message 2 is corresponding to a step “Random Access Response on DL-SCH”.

16. The method of claim 11, wherein the grouping information is additional information field in the said specific message/signaling, as well as either a RA-RNTIs corresponding to RACH access and/or preambles corresponding to the RA-RNTI, or a mapping of radio time/frequency resource to a group and/or preambles corresponding to each group.

17. The method of claim 16, wherein a UE finds out the grouping information according to the specified message or signaling.

18. The method of claim 16, wherein the additional information field is an index to indicate how many groups or mapping, or a flag to indicate the fixed number of groups and mapping, or an index to indicate the number of fields for a UE, or a response to cause of making random access.

19. The method of claim 16, wherein a UE receives the mapping of preambles to each group for a set of RA-RNTIs or a set of radio time or frequency resources according to standardized rules or calculation or mapping.

20. A method for handling a random access procedure in a user equipment, called UE hereinafter, of a wireless communications system comprising:
detecting or extracting information intended to the UE according to a derived or received grouping information.

21. A method for handling a random access procedure in a network of a wireless communications system comprising:
dividing a message 2 into certain number of sub-messages each conveying information for a group of UEs.

22. The method of claim 21, wherein the message 2 is corresponding to a step “Random Access Response on DL-SCH”.

23. The method of claim 21, wherein each UE of the group knows which group it belongs to, what information on control channel is intended to or addressed to it, what information is to distinguish the group or which radio time/frequency resource it shall monitor/receive, and which part of sub-message it shall receive or detect.

24. The method of claim 21, wherein the number of UEs in each the said group is different, or the number of bits used for preamble identifier in different sub-message is different.

25. A method for handling a random access procedure in a wireless communications system comprising:
when a RA-RNTI with a first number of bits is utilized for representing a group, dividing the RA-RNTI into at least a first part for distinguishing the group and a second part for conveying additional control information on downlink control channel.

26. The method of claim 25, wherein the second part can indicate control information of sub-message, or how many RA-RNTIs to decide whether need to keep monitoring the control channel.

27. A method for handling a random access procedure in a wireless communications system comprising:
a UE having received information or grouping information of a random access procedure, a network addressing information corresponding to a UE group to a UE via RA-RNTI, or transmitting information corresponding to the UE group via specified radio resources.

28. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
a network dividing access resources of a random access channel into at least one group, a UE randomly choosing a group of the at least group when the UE performs random access preamble or dedicated preamble based procedures.

29. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
dividing a plurality of random access preambles or preambles used in accesses of a random access channel into at least one group; and
making each of the at least one group to be mapped to or configured to at least one RA-RNTI or radio time and frequency resources, or using at least one RA-RNTI or radio time and frequency resources to represent mapping of each of the at least one group.

30. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
determining characteristic of access of a random access channel in a specific or dynamic manner.

31. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
transmitting decision or configuration corresponding to information or grouping information of the random access procedure to a UE via a specified message or signaling transmitted by a network.

32. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
detecting or extracting information intended to the UE according to a derived or received grouping information.

33. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
dividing a message 2 into certain number of sub-messages each conveying information for a group of UEs.

34. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
when a RA-RNTI with a first number of bits is utilized for representing a group, dividing the RA-RNTI into at least a first part for distinguishing the group and a second part for conveying additional control information on downlink control channel.

35. A communications device for accurately handling a random access procedure in a wireless communications system comprising:
a control circuit for realizing functions of the communications device;
a processor installed in the control circuit, for executing a program code to command the control circuit; and
a memory installed in the control circuit and coupled to the processor for storing the program code;
wherein the program code comprises:
a UE having received information or grouping information of a random access procedure, a network addressing information corresponding to a UE group to a UE via RA-RNTI, or transmitting information corresponding to the UE group via specified radio resources.
